(19) United States
(12) Patent Application Publication
(10) Pub. No.: US 2014/0033058 A1
(43) Pub. Date: Jan. 30, 2014

(54) USE OF MULTIPLE MOBILE DEVICES TO CONTROL AN APPLICATION

(71) Applicant: Erik Perotti, Santa Cruz, CA (US)

(72) Inventor: Erik Perotti, Santa Cruz, CA (US)

(73) Assignee: PLANTRONICS, INC., Santa Cruz, CA (US)

(21) Appl. No.: 13/562,095

(22) Filed: Jul. 30, 2012

(51) Int. Cl. G06F 15/16; G06F 3/01

(52) U.S. Cl. 715/740

(57) ABSTRACT

Disclosed herein are computer-implemented methods and computer-readable media embodying instructions executable by a first computer to perform functions comprising: receiving a first user input from a user of the first computer, wherein the first user input represents a command to take control of an application executing on a second computer; responsive to receiving the first user input, taking the control of the application executing on the second computer; receiving a second user input from the user of the first computer while keeping the control of the application executing on the second computer, wherein the second user input represents a command to pass the control of the application to a third computer; and responsive to receiving the second user input, passing the control of the application to the third computer.

### FIELD

The present disclosure relates generally to controlling the execution of software applications. More particularly, the present disclosure relates to using multiple mobile devices to control a software application.

### BACKGROUND

Today it is common to deliver a presentation to a group using a presentation software application executing on a computer. Often the display produced by the application is routed to a projector for easy viewing by the entire group. It is also common to have multiple presenters in a single presentation, each taking turns describing the displayed presentation slides. One problem with this approach lies in passing control from one presenter to the next. One common solution is to physically pass a simple remote control from one presenter to the next. Another common solution is to shout instructions to an assistant operating the computer.

### SUMMARY

In general, in one aspect, an embodiment features computer-readable media embodying instructions executable by a first computer to perform functions comprising: receiving a first user input from a user of the first computer, wherein the first user input represents a command to take control of an application executing on a second computer; responsive to receiving the first user input, taking the control of the application executing on the second computer; receiving a second user input from the user of the first computer while keeping the control of the application executing on the second computer, wherein the second user input represents a command to pass the control of the application to a third computer; and responsive to receiving the second user input, passing the control of the application to the third computer.

Embodiments of the computer-readable media can include one or more of the following features. In some embodiments, the functions further comprise: receiving a third user input from the user of the first computer prior to passing the control of the application to the third computer, wherein the third user input represents a command to invite a user of the third computer to take the control of the application; and responsive to receiving the third user input, sending a first message to the third computer, wherein the first message represents an invitation to take the control of the application; wherein the control of the application is passed to the third computer only subsequent to an acceptance of the invitation to take the control of the application. In some embodiments, the first message further represents: an identifier of the second computer; an identifier of the application; and a starting time and a duration for an interval, wherein the user of the third computer can take the control of the application only during the interval. In some embodiments, the functions further comprise: receiving a second message from the third computer prior to passing the control of the application to the third computer, wherein the second message represents an acceptance of the invitation to take the control of the application; and responsive to receiving the second message, and prior to passing the control of the application to the third computer, displaying an indication of the acceptance of the invitation to take the control of the application. In some embodiments, the functions further comprise: sending the first message to the third computer prior to taking the control of the application executing on the second computer. In some embodiments, the functions further comprise: sending the first message to the third computer subsequent to taking the control of the application executing on the second computer. In some embodiments, the functions further comprise: receiving a third user input from a user of the first computer subsequent to passing the control of the application to the third computer, wherein the third user input represents a command to revoke the control of the application executing on the second computer; responsive to receiving the third user input, revoking the control of the application executing on the second computer.

In general, in one aspect, an embodiment features computer-readable media embodying instructions executable by a first computer to perform functions comprising: receiving a first message from a second computer, wherein the second computer has control of a application executing on a third computer, and wherein the first message represents a passing of the control of the application from the second computer to the first computer; responsive to receiving the first message, displaying an indication of the passing of the control of the application; and responsive to receiving the first message, taking the control of the application.

Embodiments of the computer-readable media can include one or more of the following features. In some embodiments, the functions further comprise: receiving a second message from a second computer prior to receiving the first message, wherein the second message represents an invitation to take the control of the application; and responsive to receiving the second message, displaying an indication of the invitation to take the control of the application. In some embodiments, the second message further represents: an identifier of the third computer; an identifier of the application; and a starting time and a duration for an interval, wherein the user of the first computer can take the control of the application only during the interval. In some embodiments, the functions further comprise: subsequent to displaying the indication of the invitation to take the control of the application, receiving a first user input from the user of the first computer, wherein the first user input represents a command to accept the invitation to take the control of the application; and responsive to receiving the first user input, sending a third message to the second computer, wherein the third message represents an acceptance of the invitation to take the control of the application; wherein the control of the application is passed to the first computer only subsequent to sending the third message to the second computer. In some embodiments, the functions further comprise: receiving a second user input from the user of the first computer while keeping the control of the application executing on the third computer, wherein the second user input represents a command to pass the control of the application to the second computer; and responsive to receiving the second user input, passing the control of the application to the second computer. In some embodiments, the functions further comprise: receiving a second user input from the user of the first computer while keeping the control of the application executing on the third computer, wherein the second user input represents a command to pass the control of the application to a fourth computer; and responsive to receiving the second user input, passing the control of the application to the fourth computer.

In general, in one aspect, an embodiment features a computer-implemented method for a first computer, the method comprising: receiving a first user input from a user of the first computer, wherein the first user input represents a command to take control of a application executing on a second computer; responsive to receiving the first user input, taking the control of the application executing on the second computer; receiving a second user input from the user of the first computer while keeping the control of the application executing on the second computer, wherein the second user input represents a command to pass the control of the application to a third computer; and responsive to receiving the second user input, passing the control of the application to the third computer.

Embodiments of the computer-implemented method can include one or more of the following features. Some embodiments comprise receiving a third user input from the user of the first computer prior to passing the control of the application to the third computer, wherein the third user input represents a command to invite a user of the third computer to take the control of the application; and responsive to receiving the third user input, sending a first message to the third computer, wherein the first message represents an invitation to take the control of the application; wherein the control of the application is passed to the third computer only subsequent to an acceptance of the invitation to take the control of the application. In some embodiments, the first message further represents: an identifier of the second computer; an identifier of the application; and a starting time and a duration for an interval, wherein the user of the third computer can take the control of the application only during the interval. Some embodiments comprise receiving a second message from the third computer prior to passing the control of the application to the third computer, wherein the second message represents an acceptance of the invitation to take the control of the application; and responsive to receiving the second message, and prior to passing the control of the application to the third computer, displaying an indication of the acceptance of the invitation to take the control of the application. Some embodiments comprise sending the first message to the third computer prior to taking the control of the application executing on the second computer. Some embodiments comprise sending the first message to the third computer subsequent to taking the control of the application executing on the second computer. Some embodiments comprise receiving a third user input from a user of the first computer subsequent to passing the control of the application to the third computer, wherein the third user input represents a command to revoke the control of the application executing on the second computer; responsive to receiving the third user input, revoking the control of the application executing on the second computer.

The details of one or more implementations are set forth in the accompanying drawings and the description below. Other features will be apparent from the description and drawings, and from the claims.

### DESCRIPTION OF DRAWINGS

FIG. 1 shows elements of a presentation system according to some embodiments of the present disclosure.

FIG. 2 shows a process for the presentation system of FIG. 1 according to embodiments of the present disclosure where the second presenter is invited to take control of the presentation application after the presentation application is launched, and returns the control to the first presenter.

FIGS. 3A and 3B show a process for the presentation system of FIG. 1 according to embodiments of the present disclosure where the first presenter invites two presenters to take control of the presentation application before launching the presentation application, and the second presenter passes the control to the third presenter.

FIG. 4 shows a process for the remote control app of FIG. 1 according to embodiments of the present disclosure where the first presenter invites the second presenter to take control of the presentation application.

FIG. 5 shows a presentation list screen according to one embodiment.

FIG. 6 shows a settings screen according to one embodiment.

FIG. 7 shows a contacts screen according to one embodiment.

FIG. 8 shows the contacts screen of FIG. 7 with the in-line error message shown.

FIG. 9 shows settings screen of FIG. 6 with the in-line confirmation notification shown.

FIG. 10 shows a process for the second smartphone of FIG. 1 according to embodiments of the present disclosure where the second presenter receives an invitation, from the first presenter, to take control of the presentation application.

FIG. 11 shows a select presenter screen according to one embodiment.

FIG. 12 shows a presentation screen for the passive mode according to one embodiment.

FIG. 13 shows the select presenter screen of FIG. 11 with the “invitation expired” notification shown.

FIG. 14 shows the select presenter screen of FIG. 11 with the “please wait” notification shown.

FIG. 15 shows a process for the remote control app of FIG. 1 according to embodiments of the present disclosure where the first presenter transfers control of the presentation application to the second presenter.

FIG. 16 shows the presentation screen of FIG. 12 in active mode.

FIG. 17 shows the presentation screen of FIG. 12 with the in-line error message shown.

FIG. 19 illustrates a presentation system according to an embodiment where, instead of controlling a presentation application, presenters control slide shows created by the presentation application.

FIG. 20 illustrates a presentation system according to an embodiment where a slide show is implemented in a master/drone manner.

The leading digit(s) of each reference numeral used in this specification indicates the number of the drawing in which the reference numeral first appears.

### DETAILED DESCRIPTION

Embodiments of the present disclosure provide shared control of an application using multiple mobile devices. In the disclosed embodiments, the application is described as a presentation application that displays a series of slides under user control. The application can execute on a computer that is local to the user or remote from the user. For example, the application can execute on a computer implemented as a cloud server. However, any sort of application can be controlled according to the techniques described herein. In the disclosed embodiments, the mobile devices are described as smartphones. However, the smartphones can be replaced with any sort of computer capable of implementing the functions described herein, including computers that are not mobile. For example, the smartphones can be replaced with tablet computers, laptop computers, desktop computers, and the like.

According to the disclosed embodiments, the control exercised by the mobile devices is limited to applications executing on the computer. That is, the mobile devices are not allowed to control the operating system of the computer. In some embodiments, only one mobile device at a time is allowed to control the application executing on the computer. Control is shared by passing control from one mobile device to another. In other embodiments, multiple mobile devices can control the application simultaneously. A presenter can also control the application directly using the computer on which the application is executing. In some embodiments, control of the application can be passed between mobile devices automatically in response to some event. For example, if a presenter receives a phone call while controlling the application, and accepts the phone call, then control of the application is automatically passed to another mobile device. In some embodiments, presenters can use the mobile devices to communicate with each other during the presentation, for example by talking, sending text messages, and the like.

In some embodiments, the mobile devices are managed using invitations. That is, before a mobile device can take control of the application executing on the computer, that mobile device must receive an invitation from a presentation organizer, and must accept that invitation. The invitation and acceptance can take the form of an email message or the like. The invitation and acceptance can take place before the presentation or during the presentation. The presentation organizer can be a presenter, but this is not required.

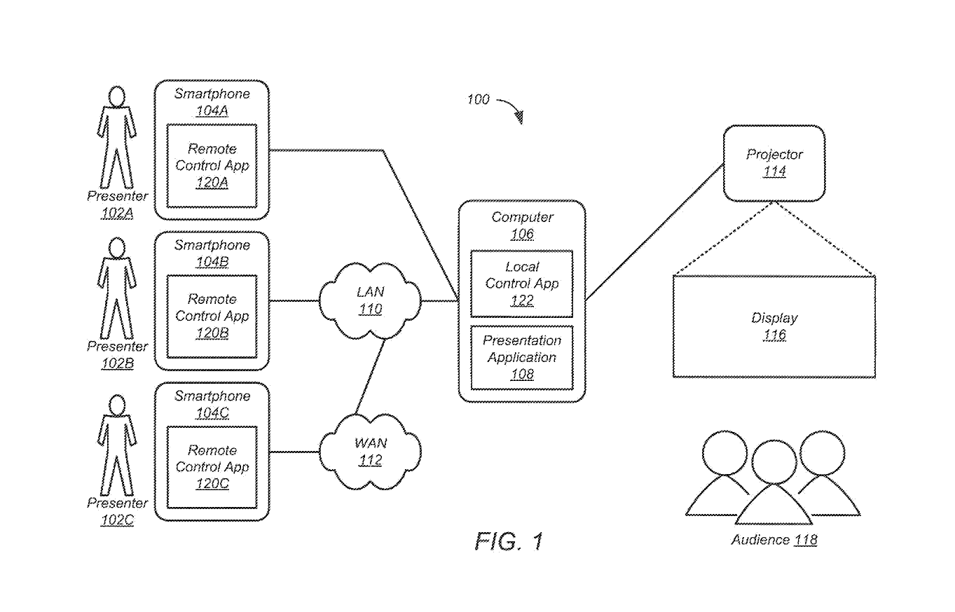

FIG. 1 shows elements of a presentation system 100 according to some embodiments of the present disclosure. Although in the described embodiments, the elements of the presentation system 100 are presented in one arrangement, other embodiments may feature other arrangements, as will be apparent to one skilled in the relevant arts based on the disclosure and teachings provided herein. For example, the elements of the presentation system 100 can be implemented in hardware, software, or combinations thereof.

Referring to FIG. 1, presentation system 100 includes three presenters 102A, 102B, and 102C controlling a presentation for an audience 118. For clarity, only three presenters 102 are shown in FIG. 1. However, any number of presenters can share control of the presentation. The presenters 102 control the presentation using respective software applications 120A, 120B, and 120C, referred to herein as “remote control apps” 120, executing on respective smartphones 104A, 104B, and 104C. The remote control apps 120 communicate with a software application 122, referred to herein as “local control app” 122, executing on a computer 106, to control a presentation application 108 executing on the computer 106. The display produced by the presentation application 108 is fed to a projector 114 that projects a display 116 for the audience 118.

Remote control apps 120 can communicate with local control app 122 using any sort of protocol. According to one embodiment, local control app 122 can control presentation application 108 executing on computer 106 by exchanging JavaScript Object Notation (JSON) objects with an application programming interface (API) of the application 108. JSON is described in RFC 4627, which is incorporated by reference herein. In other embodiments, local control app 122 can control presentation application 108 executing on computer 106 using other techniques, for example using other object types such as XML and the like. The presentation application 108 executing on computer 106 can also be controlled by a user of the computer 106.

In FIG. 1, the smartphones 104 are connected to the computer 106 executing the presentation application 108 in different ways. The first smartphone 104A has a direct connection, which can be wired or wireless. For example, the direct connection can be implemented as a USB cable, as a Bluetooth connection, or the like. Due to the nature of the direct connection, the first presenter 102A must be in the same location as the computer 106. The second smartphone 104B connects to the computer 106 over a local-area network (LAN) 110, which can be wired or wireless. For example, the LAN 110 can be a WiFi LAN or the like. The nature of this connection allows the second presenter 102B to control the computer 106 executing the presentation application 108 from a different room or building. The third smartphone 104C connects to the computer 106 over a wide-area network (WAN) 112 connected to LAN 110. For example, the WAN 112 can be the Internet or the like. The nature of this connection allows the third presenter 102C to control the computer 106 executing the presentation application 108 from a different city or country. The connections in FIG. 1 are shown by way of illustration, not limitation. Any sort of connection can be used between a smartphone 104 and the computer 106 executing the presentation application 108.

In some embodiments, the remote control apps 120 allow remote presenters 102 to communicate with audience 118. For example, presenter 102B can use his smartphone 104B to describe the slide being shown, and this audio feed can be rendered for audience 118. In some embodiments, the remote control apps 120 allow the presenters 102 to communicate with each other in order to coordinate the presentation.

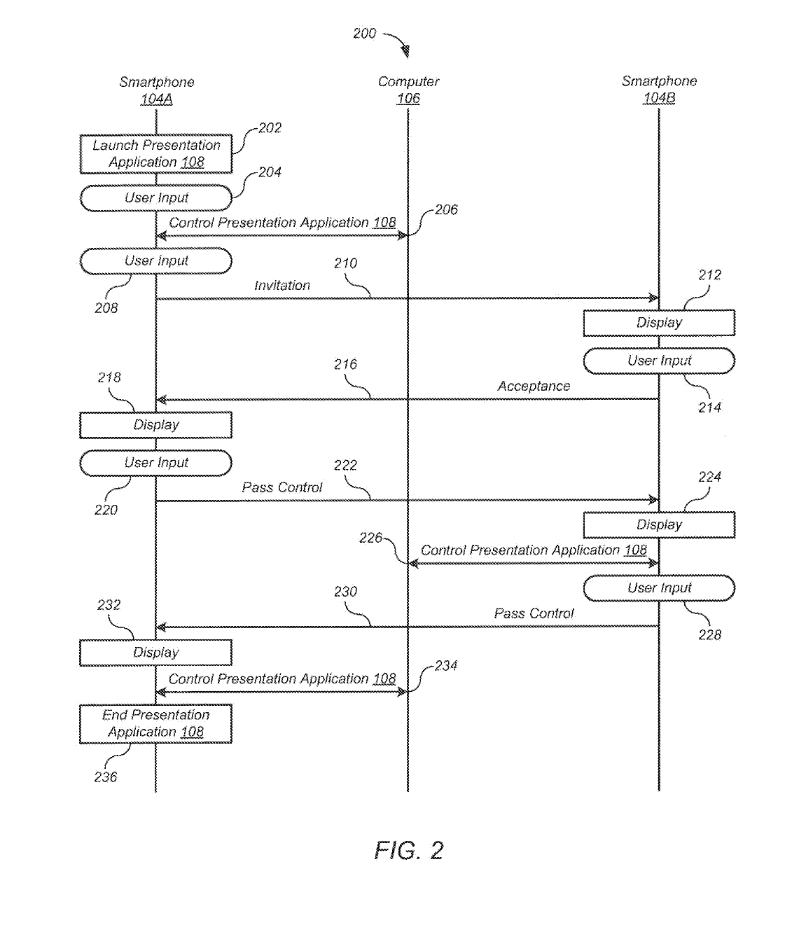

FIG. 2 shows a process 200 for the presentation system 100 of FIG. 1 according to embodiments of the present disclosure where the second presenter 102B is invited to take control of the presentation application 108 after the presentation application 108 is launched, and returns control to the first presenter 102. Although in the described embodiments, the elements of process 200 are presented in one arrangement, other embodiments may feature other arrangements, as will be apparent to one skilled in the relevant arts based on the disclosure and teachings provided herein. For example, in various embodiments, some or all of the steps of process 200 can be executed in a different order, concurrently, and the like.

Referring to FIG. 2, at 202, the presentation application 108 begins executing on computer 106. The presentation application 108 can be launched by the first presenter 102A by operating the computer 106 directly, or by using the first smartphone 104A. Alternatively, the presentation application 108 can be launched by an assistant. At 204, the first smartphone 104A receives a user input from the first presenter 102A. The user input represents a command to take control of the presentation application 108 executing on computer 106. At 206, responsive to receiving the user input, the first smartphone 104A takes control of the presentation application 108 executing on computer 106.

At 208, the first smartphone 104A receives a user input from the first presenter 102A. The user input represents a command to invite the second presenter 102B to take control of the presentation application 108 executing on computer 106. At 210, responsive to receiving the user input, the first smartphone 104A sends an invitation message to the second smartphone 104B. As used herein, the term “message” generally refers to an electronic signal representing a digital message. The invitation message represents an invitation to take control of the presentation application 108 executing on computer 106. In some embodiments, the invitation message represents an identifier of the computer 106, an identifier of the presentation application 108, and a starting time and a duration for an interval, where the user of the third computer can take control of the application only during the interval. In some embodiments, the message can include a globally unique identifier (GUID). The invitation message can be included in a meeting invitation such as those generated by calendar applications, personal information manager applications, and the like.

At 212, the second smartphone 104A receives the invitation message and, responsive to receiving the message, displays an indication of the invitation to take control of the presentation application 108 executing on computer 106. The second presenter 102B can view the invitation and accept or decline. In the example of FIG. 2, the second presenter 102B accepts the invitation. That is, at 214, the second smartphone 104B receives a user input from the second presenter 1028. The user input represents a command to accept the invitation to take control of the presentation application 108 executing on computer 106. At 216, responsive to receiving the user input, the second smartphone 104B sends an acceptance message to the first smartphone 104A. The acceptance message represents an acceptance of the invitation to take control of the presentation application 108 executing on computer 106.

At 218, the first smartphone 104A receives the acceptance message, and displays an indication of the acceptance of the invitation to take control of the presentation application 108 executing on computer 106. At 220, the first smartphone 104A receives a user input from the first presenter 102A while keeping control of the presentation application 108 executing on computer 106. The user input represents a command to pass control of the presentation application 108 to the second smartphone 104B. At 222, responsive to receiving the user input, the first smartphone 104A sends a pass control message to the second smartphone 104B. The pass control message represents a passing of control of the presentation application 108 from the first smartphone 104A to the second smartphone 104B.

At 224, the second smartphone 104B receives the message and, responsive to receiving the message, displays an indication of the passing of control of the presentation application 108 from the first smartphone 104A to the second smartphone 104B. At 226, responsive to receiving the message, the second smartphone 104B takes control of the presentation application 108 executing on computer 106.

When the second presenter 102B is done with his part of the presentation, he returns control of the presentation application 108 to the first presenter 102A, or to the first presenter 102 to reclaim control of the presentation application 108. In other embodiments, the second presenter 102B can pass control of the presentation application 108 to the third presenter 102C. At 228, the second smartphone 104B receives a user input from the second presenter 102B while keeping control of the presentation application 108 executing on computer 106. The user input represents a command to pass control of the presentation application 108 to the first smartphone. 104A. At 230, responsive to receiving the user input, the second smartphone 104B sends a pass control message to the first smartphone 104A. The pass control message represents a passing of control of the presentation application 108 from the second smartphone 104B to the first smartphone 104A.

At 232, the first smartphone 104A receives the message and, responsive to receiving the message, displays an indication of the passing of control of the presentation application 108 from the second smartphone 104B to the first smartphone 104A. At 234, responsive to receiving the message, the first smartphone 104A takes control of the presentation application 108 executing on computer 106. When the first presenter 102A is done presenting, the presentation application 108 can be terminated, at 236.

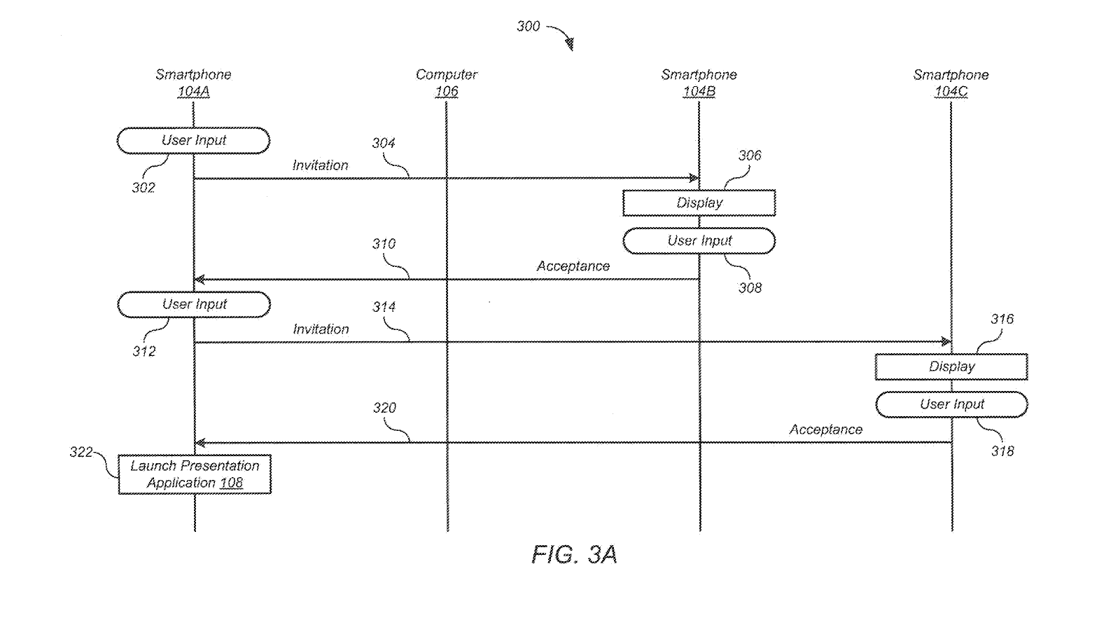

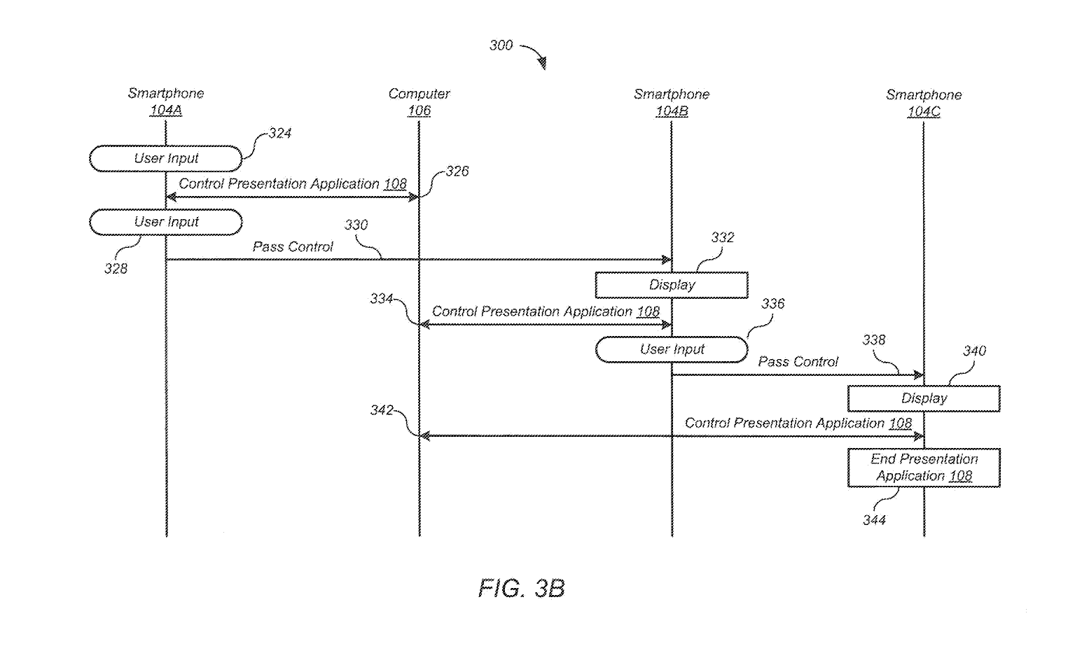

FIGS. 3A and 3B show a process 300 for the presentation system 100 of FIG. 1 according to embodiments of the present disclosure where the first presenter invites two presenters 102B and 102C to take control of the presentation application 108 before launching the presentation application 108, and the second presenter 102B passes control to the third presenter 102C. Although in the described embodiments, the elements of process 300 are presented in one arrangement, other embodiments may feature other arrangements, as will be apparent to one skilled in the relevant arts based on the disclosure and teachings provided herein. For example, in various embodiments, some or all of the steps of process 300 can be executed in a different order, concurrently, and the like.

Referring to FIG. 3A, the first presenter 102A invites the second presenter 102B. In particular, at 302, the first smartphone 104A receives a user input from the first presenter 102A. The user input represents a command to invite the second presenter 102B to take control of the presentation application 108. At 304, responsive to receiving the user input, the first smartphone 104A sends an invitation message to the second smartphone 104B. The invitation message represents an invitation to take control of the presentation application 108. At 306, the second smartphone 104B receives the invitation message and responsive to receiving the message, displays an indication of the invitation to take control of the presentation application 108 executing on computer 106. The second presenter 102B can view the invitation and accept or decline. In the example of FIG. 3, the second presenter 102B accepts the invitation. That is, at 308, the second smartphone 104B receives a user input from the second presenter 102B. The user input represents a command to accept the invitation to take control of the presentation application 108 executing on computer 106. At 310, responsive to receiving the user input, the second smartphone 104B sends an acceptance message to the first smartphone 104A. The acceptance message represents an acceptance of the invitation to take control of the presentation application 108.

The first presenter 102A then invites the third presenter 102C. In particular, at 312, the first smartphone 104A receives a user input from the first presenter 102A. The user input represents a command to invite the third presenter 102C to take control of the presentation application 108. At 314, responsive to receiving the user input, the first smartphone 104A sends an invitation message to the third smartphone 104C. The invitation message represents an invitation to take control of the presentation application 108. At 316, the third smartphone 104C receives the invitation message and, responsive to receiving the message, displays an indication of the invitation to take control of the presentation application 108 executing on computer 106. The third presenter 102C can view the invitation and accept or decline. In the example of FIG. 3, the third presenter 102C accepts the invitation. That is, at 318, the third smartphone 104C receives a user input from the third presenter 102C. The user input represents a command to accept the invitation to take control of the presentation application 108 executing on computer 106. At 320, responsive to receiving the user input, the third smartphone 104C sends an acceptance message to the first smartphone 104A. The acceptance message represents an acceptance of the invitation to take control of the presentation application 108.

At 322, the presentation application 108 begins executing on computer 106. The presentation application 108 can be launched by the first presenter 102A by operating the computer 106 directly, or by using the first smartphone 104A. Alternatively, the presentation application 108 can be launched by an assistant. Referring now to FIG. 3B, at 324, the first smartphone 104A receives a user input from the first presenter 102A. The user input represents a command to take control of the presentation application 108 executing on computer 106. At 326, responsive to receiving the user input, the first smartphone 104A takes control of the presentation application 108 executing on computer 106.

At 328, the first smartphone 104A receives a user input from the first presenter 102A while keeping control of the presentation application 108 executing on computer 106. The user input represents a command to pass control of the presentation application 108 to the second smartphone 104B. At 330, responsive to receiving the user input, the first smartphone 104A sends a pass control message to the second smartphone 104B. The pass control message represents a passing of control of the presentation application 108 from the first smartphone 104A to the second smartphone 104B.

At 332, the second smartphone 104B receives the message and, responsive to receiving the message, displays an indication of the passing of control of the presentation application 108 from the first smartphone 104A to the second smartphone 104B. At 334, responsive to receiving the message, the second smartphone 104B takes control of the presentation application 108 executing on computer 106.

When the second presenter 102B is done with his part of the presentation, he passes control of the presentation application 108 to the third presenter 102C. In other embodiments, the second presenter 102B can return control of the presentation application 108 to the first presenter 102A. At 336, the second smartphone 104B receives a user input from the second presenter 102B while keeping control of the presentation application 108 executing on computer 106. The user input represents a command to pass control of the presentation application 108 to the third smartphone 104C. At 338, responsive to receiving the user input, the second smartphone 104B sends a pass control message to the third smartphone 104C. The pass control message represents a passing of control of the presentation application 108 from the second smartphone 104B to the third smartphone 104C.

At 340, the third smartphone 104C receives the message and, responsive to receiving the message, displays an indication of the passing of control of the presentation application 108 from the second smartphone 104B to the third smartphone 104C. At 342, responsive to receiving the message, the third smartphone 104C takes control of the presentation application 108 executing on computer 106. When the third presenter 102C is done presenting, the presentation application 108 can be terminated, at 344.

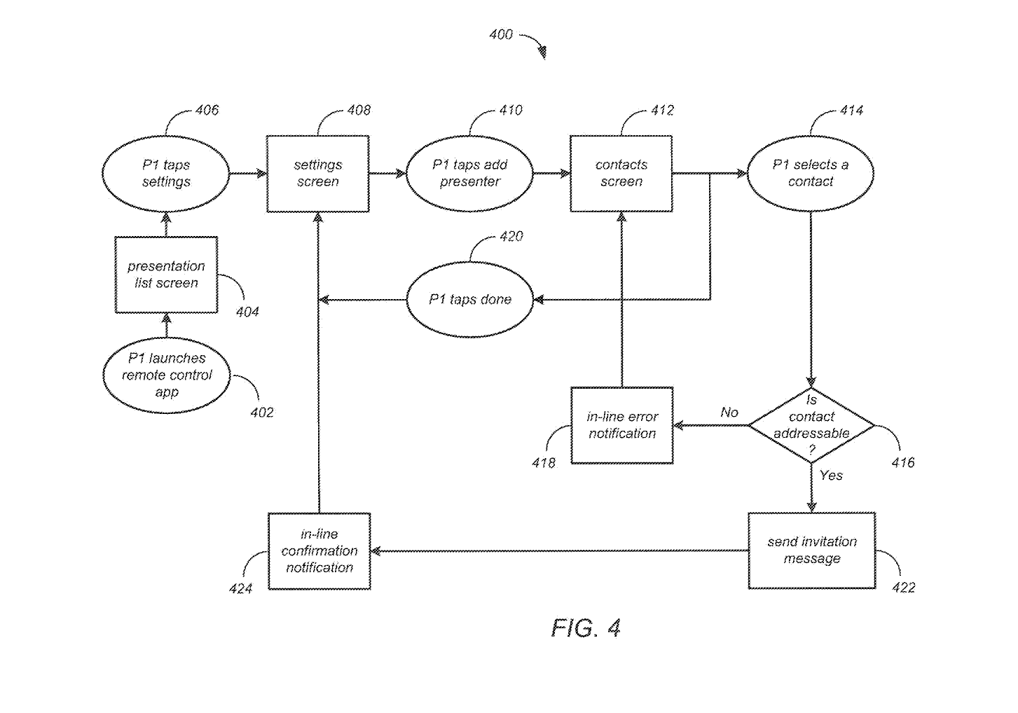

FIG. 4 shows a process 400 for the remote control app 120 of FIG. 1 according to embodiments of the present disclosure where the first presenter 102A invites the second presenter 102B to take control of the presentation application 108. Although in the described embodiments, the elements of process 400 are presented in one arrangement, other embodiments may feature other arrangements, as will be apparent to one skilled in the relevant arts based on the disclosure and teachings provided herein. For example, in various embodiments, some or all of the steps of process 400 can be executed in a different order, concurrently, and the like.

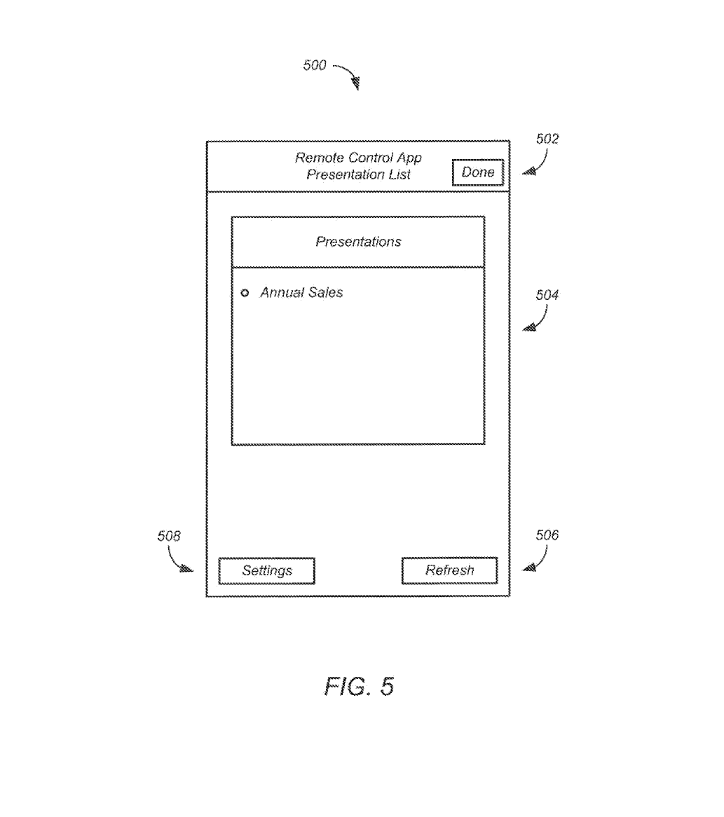

Referring to FIG. 4, at 402, the first presenter 102A (shown as “P1” in FIG. 4) launches the remote control app 120 on his smartphone 104A. In response, at 404, the smartphone 104A displays a presentation list screen for the remote control app 120. FIG. 5 shows a presentation list screen 500 according to one embodiment. Referring to FIG. 5, the presentation list screen 500 includes a “Done” button 502, a presentation list 504, a “Refresh” button 506, and a “Settings” button 508. The presentation list 504 lists current and scheduled presentations. Tapping the “Done” button 502 ends the remote control app 120. Tapping the “Refresh” button 506 refreshes the presentation list 504. Tapping the “Settings” button 508 takes the remote control app 120 to a settings screen.

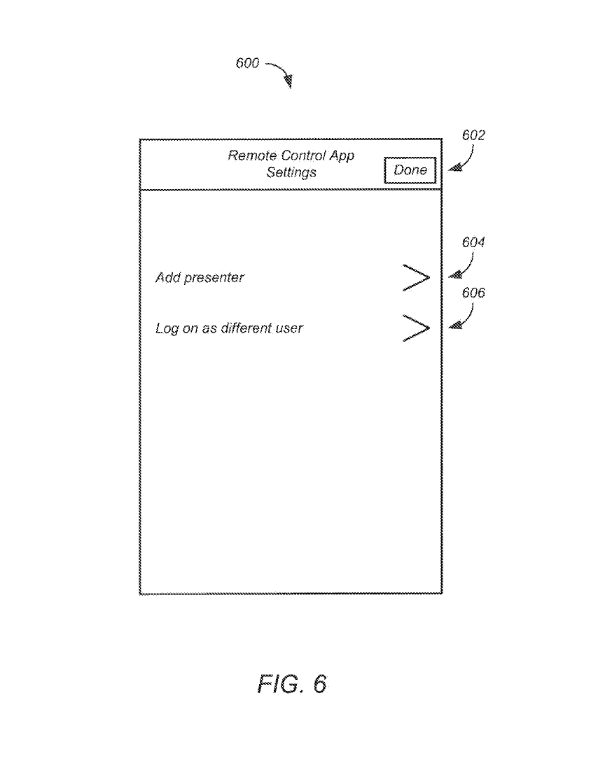

Returning to FIG. 4, at 406, the first presenter 102A taps the “Settings” button 508 on the presentation list screen 500 of the remote control app 120. In response, at 408, the remote control app 120 displays a settings screen. FIG. 6 shows a settings screen 600 according to one embodiment. Referring to FIG. 6, the settings screen 600 includes a “Done” button 602, an “Add presenter” button 604, and a “Log in as different user” button 606. Tapping the “Done” button 602 returns the remote control app 120 to the presentation list screen 500. Tapping the “Add presenter” button 604 takes the remote control app 120 to a contacts screen. Tapping the “Log in as different user” button 606 allows the user to log in as a different user.

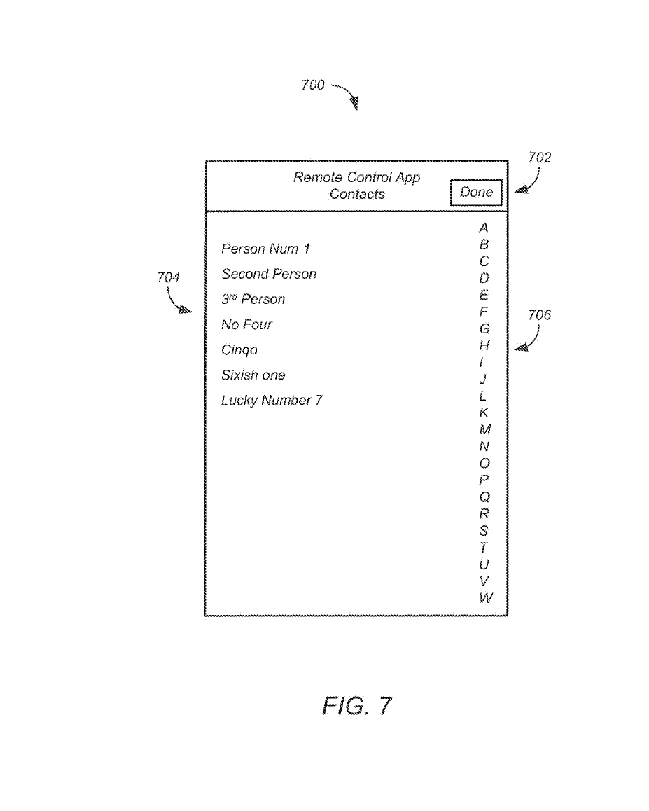

Returning to FIG. 4, at 410, the first presenter 102A taps the “Add presenter” button 604 on the settings screen 600 of the remote control app 120. In response, at 412, the remote control app 120 displays a contacts screen. FIG. 7 shows a contacts screen 700 according to one embodiment. Referring to FIG. 7, the contacts screen 700 includes a “Done” button 702, a contact list 704, and a letter list 706. At 420, tapping the “Done” button 702 returns the remote control app 120 to the settings screen 600. Tapping a name in the contact list 704 sends an invitation message to that contact. Tapping a letter in the letter list 706 causes the remote control app 120 to scroll the contacts list 704 to that letter.

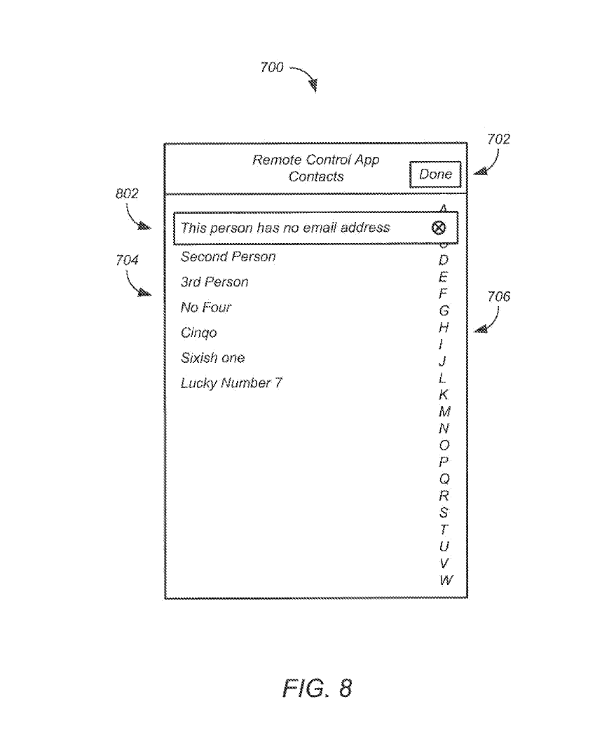

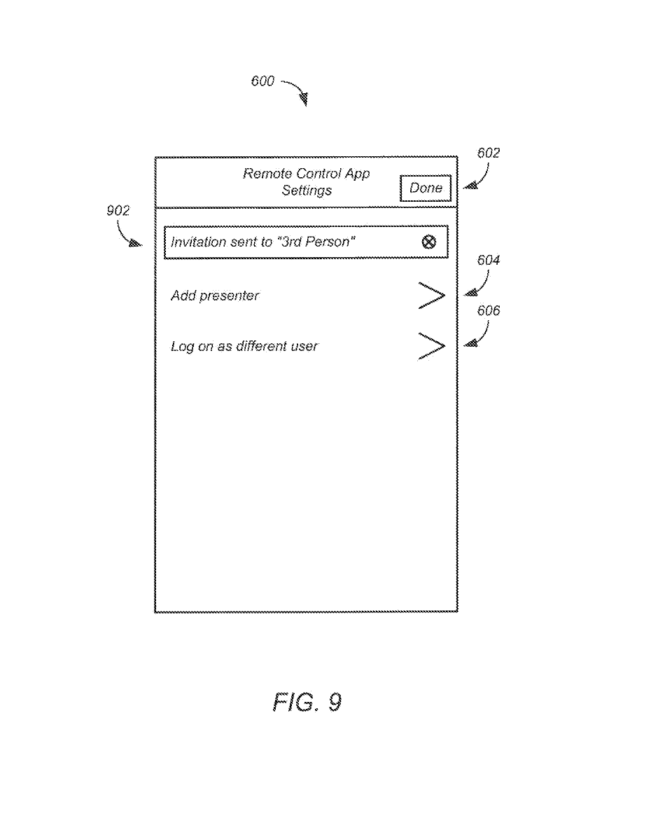

Returning to FIG. 4, at 414, the first presenter 102A selects a contact in the contact list 704. In response, the remote control app 120 attempts to send an invitation message to the selected contact. In particular, at 416, the remote control app 120 determines whether the selected contact is addressable. At 418, if the selected contact is not addressable, the remote control app 120 displays an in-line error notification on the contacts screen. FIG. 8 shows the contacts screen 700 of FIG. 7 with the in-line error message shown at 802. Returning to FIG. 4, at 416, if the selected contact is addressable, then at 422, the remote control app 120 sends an invitation message to the selected contact. The invitation message can be sent, for example, as an email message or the like. Then, at 408 and 424, the remote control app 120 returns to the settings screen and displays an in-line confirmation notification. FIG. 9 shows settings screen 600 of FIG. 6 with the in-line confirmation notification shown at 902.

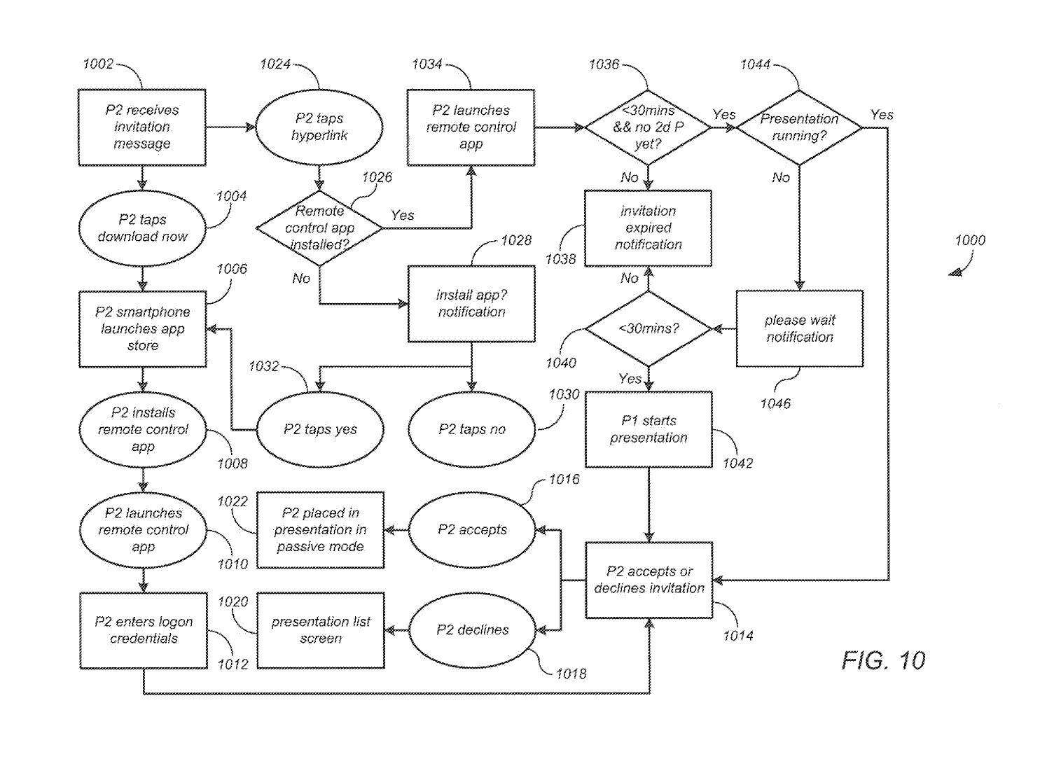

FIG. 10 shows a process 1000 for the second smartphone 104B of FIG. 1 according to embodiments of the present disclosure where the second presenter 102B receives an invitation, from the first presenter 102A, to take control of the presentation application 108. Although in the described embodiments, the elements of process 1000 are presented in one arrangement, other embodiments may feature other arrangements, as will be apparent to one skilled in the relevant arts based on the disclosure and teachings provided herein. For example, in various embodiments, some or all of the steps of process 1000 can be executed in a different order, concurrently, and the like.

Referring to FIG. 10, at 1002, the second presenter 102B (shown as “P2” in FIG. 10) receives the invitation sent by the first presenter 102A (shown as “P1” in FIG. 10). The invitation message can be, for example, an email message or the like. The invitation message includes a hyperlink and a “Download Now” button. If the second presenter 102B taps the “Download Now” button, at 1004, then his smartphone 104B launches an app store application containing the remote control app 120, at 1006. The second presenter 102B can install the remote control app 120 at 1008, and launch the remote control app 120 on his smartphone 104B at 1010. At 1012, the second presenter enters logon credentials such as an email address and password, or the like. At 1014, the remote control app 120 shows a select presenter screen that allows the second presenter 102B to accept or decline the invitation to control the presentation application 108.

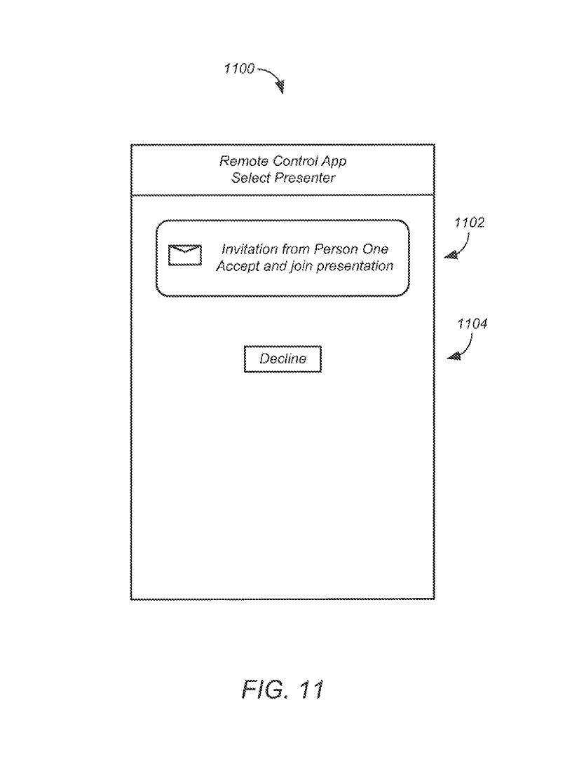

FIG. 11 shows a select presenter screen 1100 according to one embodiment. Referring to FIG. 11, the select presenter screen 1100 includes an “Accept” button 1102 and a “Decline” button 1104. The “Accept” button 1102 includes the name of the inviter, here the first presenter 102A. Tapping the “Accept” button 1102 accepts the invitation. Tapping the “Decline” button 1104 declines the invitation.

Returning to FIG. 10, if the second presenter 102B declines the invitation at 1018, then at 1020, the remote control app 120 returns to the presentation list screen 500. Alternatively, if the second presenter 102B accepts the invitation at 1016, then at 1022, the remote control app 120 places the second presenter 102B in the presentation in passive mode. That is, remote control app 120 displays a presentation screen for the passive mode that shows the display of the presentation application 108 executing on computer 106, but that does not allow the user to control the presentation application 108.

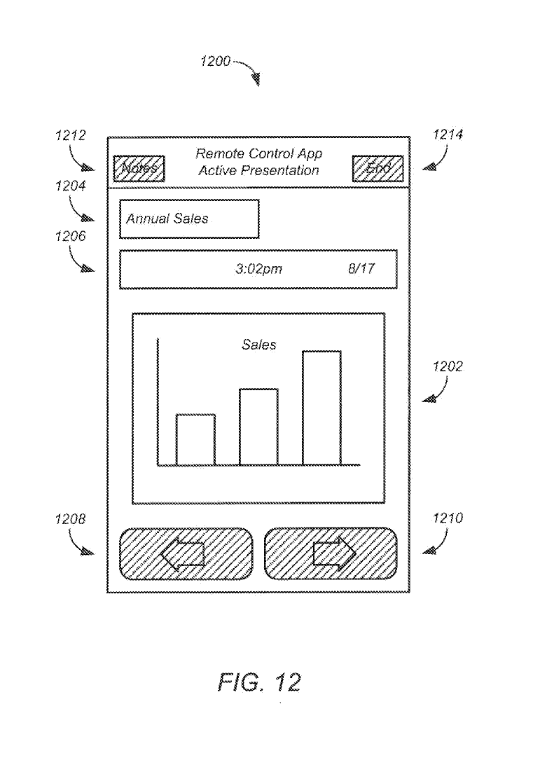

FIG. 12 shows a presentation screen 1200 for the passive mode according to one embodiment. Referring to FIG. 12, the presentation screen 1200 includes a display area 1202, a title bar 1204, an information bar 1206, a “previous slide” button 1208, a “next slide button” 1210, a ‘Notes” button 1212, and an “End” button 1214. The display area 1202 shows the current slide. The title bar 1204 shows the title of the presentation. The information bar 1206 shows the time of day, the number of the current slide, and the total number of slides. The “previous slide” button 1208, “next slide button” 1210, “Notes” button 1212, and “End” button 1214 are grayed-out (shown in FIG. 12 as cross-hatched) to indicate that they are not available in passive mode.

Returning to FIG. 10, if the second presenter 102B taps the hyperlink in the invitation message, at 1024, then his smartphone 104B determines whether the remote control app 120 is installed, at 1026. If the remote control app 120 is not installed, then, at 1028, the smartphone 104B allows the user to install the remote control app 120. If the second presenter 102B declines to install the remote control app 120, at 1030, then the process 1000 ends. Alternatively, if the second presenter 102B chooses to install the remote control app 120, at 1032, then his smartphone 104B launches an app store application containing the remote control app 120, at 1006.

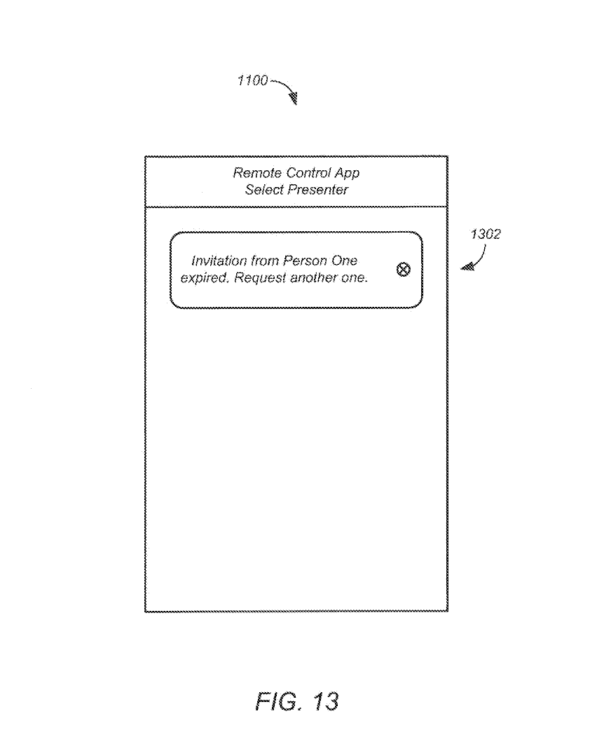

Alternatively, if at 1026, the remote control app 120 is installed on smartphone 104B, then the second presenter 102B launches the remote control app 120, at 1034. In some embodiments, invitations expire after a predetermined interval. In the embodiment of FIG. 10, invitations expire after 30 minutes. If the second presenter 102B does not accept the invitation within 30 minutes, at 1036, the invitation expires, and an “invitation expired” notification is displayed, at 1038. The “invitation expired” notification is displayed on the select presenter screen 1100 of FIG. 11. FIG. 13 shows the select presenter screen 1100 of FIG. 11 with the “invitation expired” notification shown at 1302. As shown in FIG. 13, the user is allowed to request another invitation.

Returning to FIG. 10, if the invitation has not expired, and at 1044, the presentation application 108 is running on computer 106, then at 1014, the remote control app 120 allows the second presenter 102B to accept or decline the invitation to control the presentation application 108.

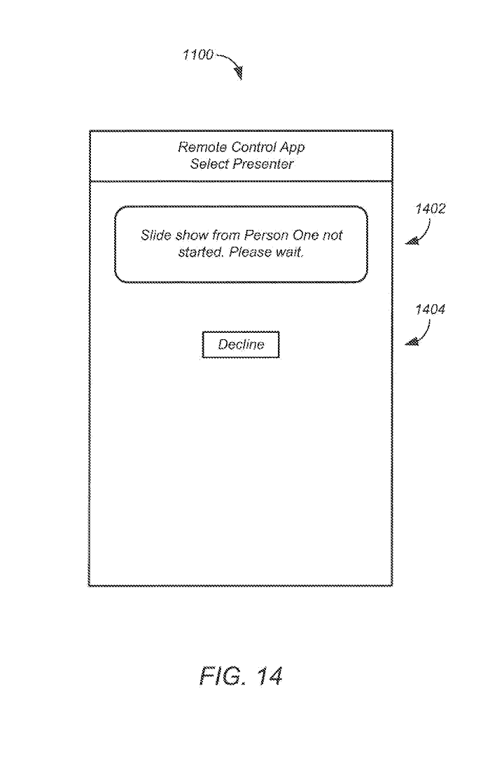

Alternatively, if the invitation has not expired, and at 1044, the presentation application 108 is not running on computer 106, then at 1046, the remote control app 120 displays a “please wait” notification. The “please wait” notification is displayed on the select presenter screen 1100 of FIG. 11. FIG. 14 shows the select presenter screen 1100 of FIG. 11 with the “please wait” notification shown at 1402. As shown in FIG. 14, the user is allowed to decline the invitation by tapping a “Decline” button 1404.

Returning to FIG. 10, at 1040, if the second presenter 102B does not accept the invitation within 30 minutes, the invitation expires, and the “invitation expired” notification is displayed, at 1038. Alternatively, at 1042, the first presenter 102A starts the presentation application 108 on computer 106. Then at 1014, the remote control app 120 allows the second presenter 102B to accept or decline the invitation to control the presentation application 108.

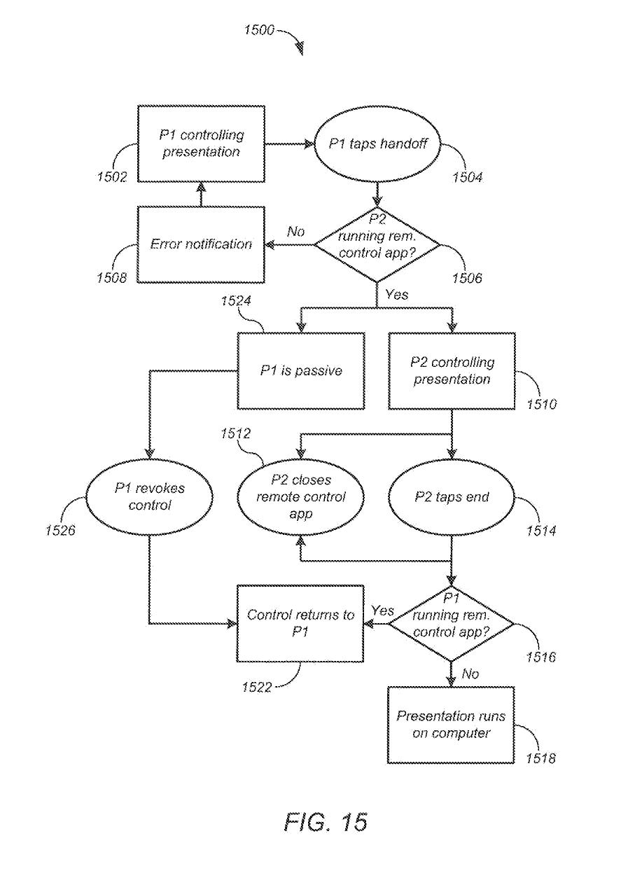

FIG. 15 shows a process 1500 for the remote control app 120 of FIG. 1 according to embodiments of the present disclosure where the first presenter I 02A transfers control of the presentation application 108 to the second presenter 102B. Although in the described embodiments, the elements of process 1500 are presented in one arrangement, other embodiments may feature other arrangements, as will be apparent to one skilled in the relevant arts based on the disclosure and teachings provided herein. For example, in various embodiments, some or all of the steps of process 1500 can be executed in a different order, concurrently, and the like.

Referring to FIG. 15, at 1502, the first presenter 102A (shown as “P1” in FIG. 15) has control of the presentation application 108. The remote control app 120A on his smartphone 104A shows the presentation screen 1200 for the active mode, that is, with all controls enabled.

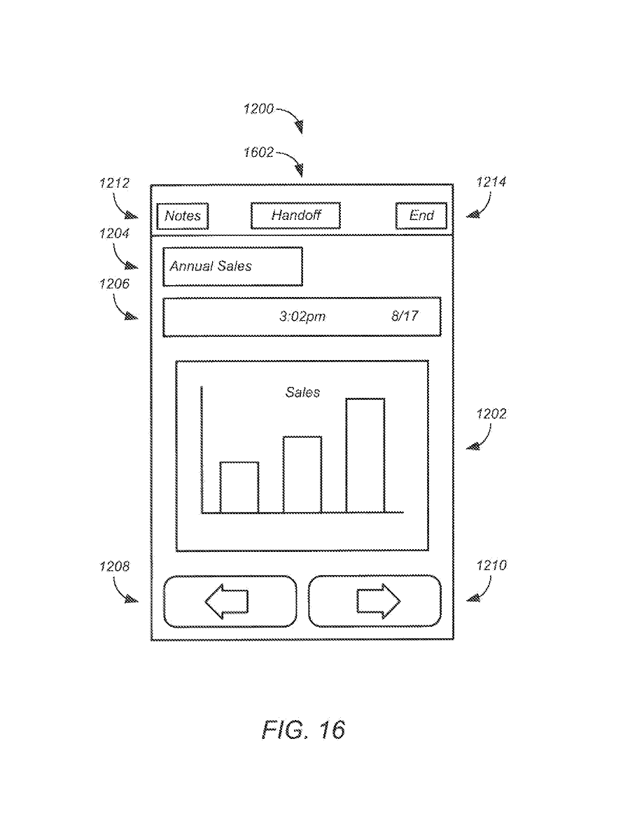

FIG. 16 shows the presentation screen 1200 of FIG. 12 with the “previous slide” button 1208, “next slide button” 1210, “Notes” button 1212, and “End” button 1214 enabled to indicate that they are available in active mode. In addition, a

“Handoff” button 1602 is displayed. Tapping the “Handoff” button 1602 transfers control of the presentation application to another presenter.

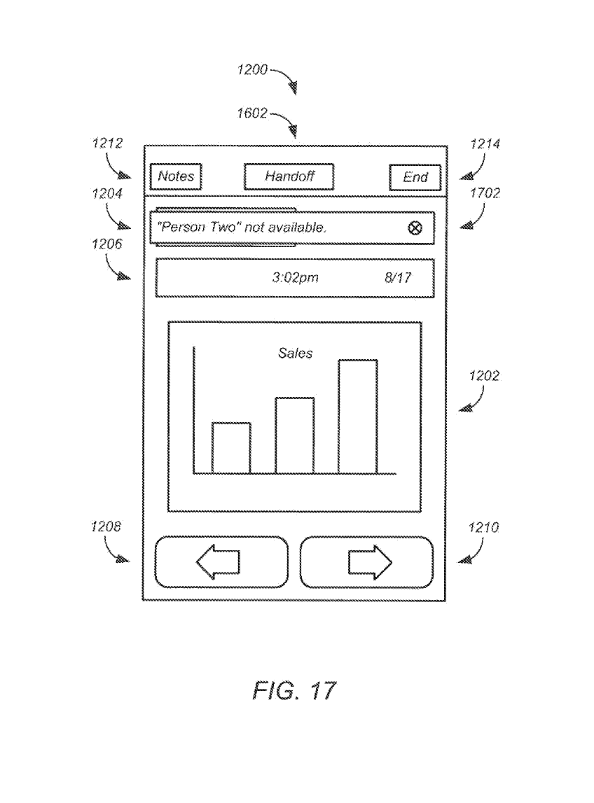

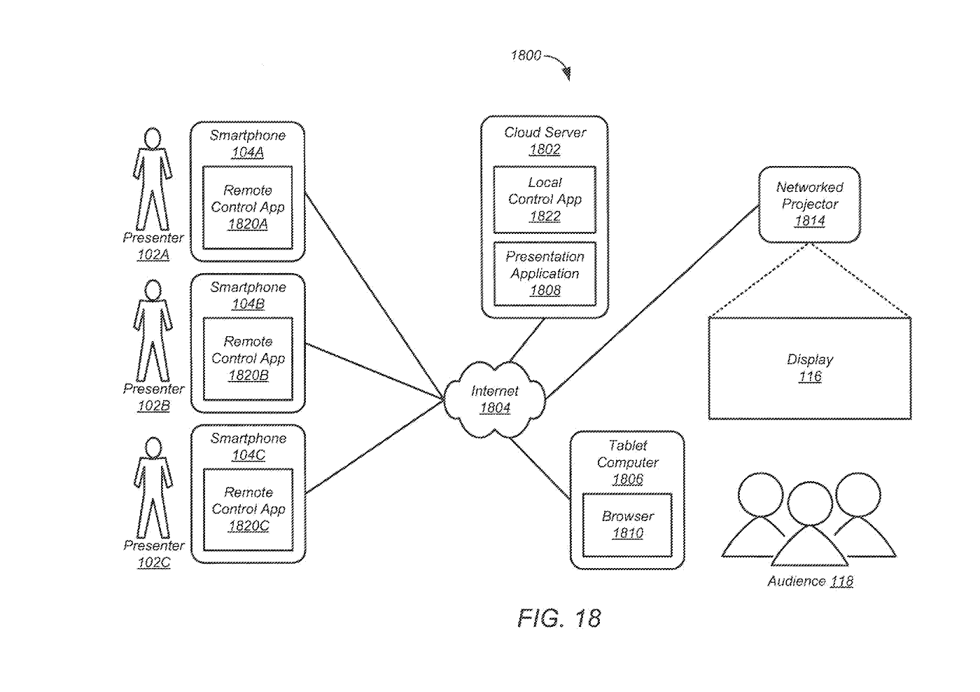

Referring to FIG. 15, at 1504, the first presenter 102B taps the “Handoff” button 1602. If at 1506, the second presenter 102B (shown as “P2” in FIG. 15) is not running the remote control app 120B on his smartphone 104B, then at 1508, the remote control app 120A running on the first presenter's smartphone 104A shows an in-line error message. FIG. 17 shows the presentation screen 1200 of FIG. 12 with the in-line error message shown at 1702.

Returning to FIG. 15, if at 1506, the second presenter 102B is running the remote control app 120B on his smartphone 104B, then control of the presentation application 108 is transferred to the second presenter 102B. Now, at 1524, the first presenter 102A is in passive mode, and so sees the presentation screen 1200 in the passive mode, for example as shown in FIG. 12. At 1510, the second presenter 102B is in active mode, controlling the presentation application 108, and so sees the presentation screen 1200 in the active mode, for example as shown in FIG. 16.

Returning to FIG. 15, at any time, the second presenter 102B can close his remote control app 120B, at 1512, or can tap the “End” button 1214, at 1514. In either case, if at 1516, the first presenter 102A is running his remote control app 120A, then at 1522, control of the presentation application 108 returns to the first presenter 102A. Alternatively, if at 1516, the first presenter 102A is not running his remote control app 120A, then at 1518, the presentation application 108 continues to execute on the computer 106.

In some embodiments, while the second presenter 102B is controlling the presentation application 108, at 1526, the first presenter 102A can revoke control at any time. In this case, at 1522, control of the presentation application 108 returns to the first presenter 102A.

In the embodiments described above, the presentation application 108 executes on a computer 106 that is in the same room as the audience 118, or at least nearby. In other embodiments, the presentation application 108 executes on a remote network server, also referred to herein as a “cloud server.” FIG. 18 shows elements of a cloud presentation system 1800 according to some embodiments of the present disclosure. Although in the described embodiments, the elements of the cloud presentation system 1800 are presented in one arrangement, other embodiments may feature other arrangements, as will be apparent to one skilled in the relevant arts based on the disclosure and teachings provided herein. For example, the elements of the cloud presentation system 1800 can be implemented in hardware, software, or combinations thereof.

Referring to FIG. 18, cloud presentation system 1800 includes three presenters 102A, 102B, and 102C controlling a presentation for an audience 118. For clarity, only three presenters 102 are shown in FIG. 18. However, any number of presenters can share control of the presentation. The presenters 102 control the presentation using respective software applications 1820A, 1820B, and 1820C, referred to herein as “remote control apps” 1820, executing on respective smartphones 104A, 104B, and 104C. The remote control apps 1820 communicate with a software application 1822, referred to herein as “local control app” 1822, executing on a cloud server 1802, to control a presentation application 1808 executing on the cloud server 1802. Output of the presentation application 1808 is rendered by a networked projector 1814 that projects a display 116 for the audience 118. Alternatively, the presentation can be viewed on a tablet computer 1806 or the like using a browser 1810 or the like. Smartphones 104, cloud server 1802, tablet computer 1806, and networked projector 1814 communicate over networks such as the Internet 1804, cellular networks, and the like.

Remote control apps 1820 can communicate with local control app 1822 using any sort of protocol. According to one embodiment, local control app 1822 can control presentation application 1808 executing on cloud server 1802 by exchanging JSON objects with an API of the application 1808. In other embodiments, local control app 1822 can control presentation application 1808 executing on cloud server 1802 using other techniques, for example using other object types such as XML and the like.

In some embodiments, the remote control apps 1820 allow remote presenters 102 to communicate with audience 118. For example, presenter 102B can use his smartphone 104B to describe the slide being shown, and this audio feed can be rendered for audience 118. In some embodiments, the remote control apps 1820 allow the presenters 102 to communicate with each other in order to coordinate the presentation.

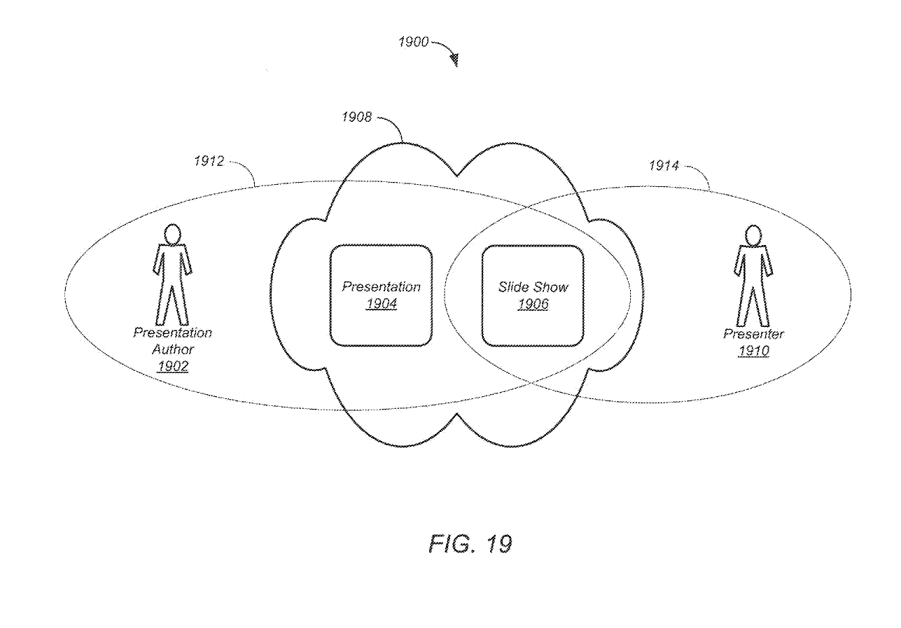

In some embodiments, instead of controlling the presentation application 1808, presenters 102 control slide shows created by the presentation application. FIG. 19 illustrates a presentation system 1900 according to one such embodiment. Referring to FIG. 19, a presentation author 1902 can create a presentation 1904, and a slide show 1906 based on that presentation 1904; in the cloud 1908. For example, the presentation author 1902 can use a local computer to control a presentation application 1808 executing on a cloud server 1802 to create the presentation 1904 and the slide show 1906. In some embodiments, the presentation author 1902 can use a presentation application 1808 executing on a local computer to create the presentation 1904, upload the presentation to the cloud 1908, and then create the slide show 1906 in the cloud 1908.

A presenter 1910 can present the slide show 1906 without using the presentation application 1808. The presentation author 1902 has permission to create, edit, and present the slide show 1906, as indicated by ellipse 1912. However, the presenter 1910 has permission only to present the slide show 1906, as indicated by ellipse 1914. The presentation 1904 can be created or edited by multiple presentation authors 1902. The slide show 1906 can be presented by multiple presentation authors 1902 and/or presenters 1910.

In some embodiments, the presentation author 1902 uploads a presentation 1904 to the cloud 1908 and enters a presentation name for the presentation 1904. A user-defined structure can be employed to organize presentations 1904 and slide shows 1906, for example by category. Then permissions can be granted to a single presentation, or to all presentations within a category. As part of the creation or upload of a presentation 1904, the presentation author 1902 can indicate the permitted slide show presenters 1910, for example by email address.

Giving the cloud presentation 1904 a unique name allows the presentation author 1902 to change presentation file names on his local computer, while keeping them defined as the same presentation 1904 in the cloud 1908. For example, a presentation author 1902 has a presentation on his local hard-drive named “why you should buy this product” and uploads it to the cloud with the name “product advantages.” The next day, that presentation author 1902 can rename the file locally “why you should buy this product 2-08-2012” and upload that newer version as an increment to the “product advantages” presentation 1904 in the cloud 1908.

An added benefit here is that the presentation files no longer have to be the same file type. For example, one can save a presentation file created by one presentation application, and then open that presentation file with a different presentation application. If the presentation file type can be converted to a standardized slide show object (across source file types), then the source file type is not relevant.

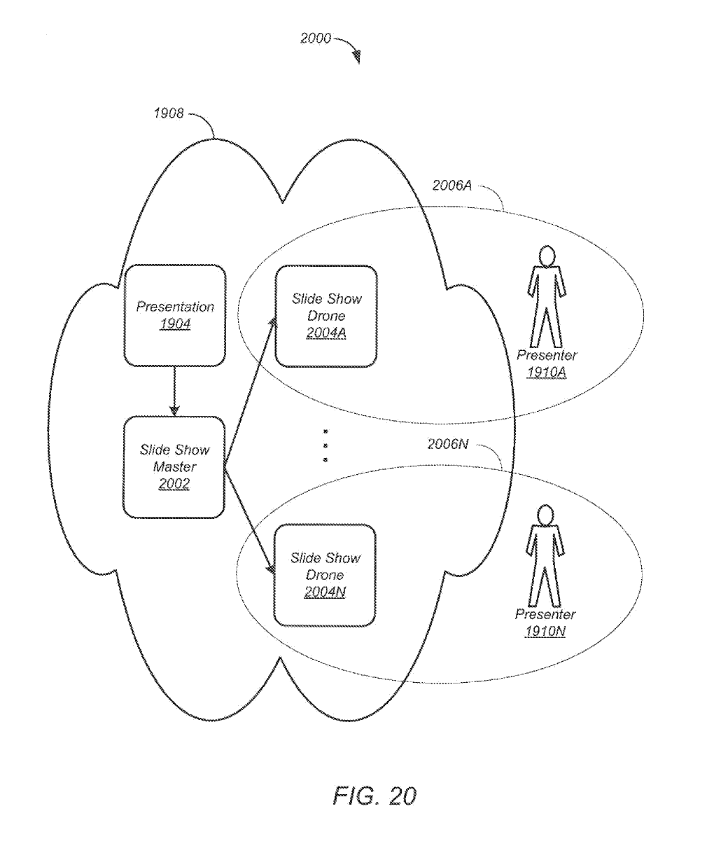

In some embodiments, the slide show 1906 can be implemented in a master/drone manner. FIG. 20 illustrates a presentation system 2000 according to one such embodiment. Referring to FIG. 20, the slide show 1906 can be made available to the presenter 1910 as a password-protected slide show object, referred to herein as a “master” slide show object 2002. The presenter 1910 can access the master slide show object 2002, for example, using the presentation list screen 500 of FIG. 5. When the presenter 1910 selects the slide show, a “drone” slide show object 2004 is created in the cloud 1908. The presenter 1910 then uses this drone object 2004 to navigate through the slide show functions: forward/back, select an arbitrary slide, and so forth. Multiple drones 2004 for one slide show master 2002 can exist at the same time, with each drone 2004 associated with a different presenter 1910. In FIG. 20, multiple drones 2004 have been spawned from a single master 2002, with each drone 2004A-2004N being associated with a respective presenter 1910A-1910N, as indicated by ellipses 2006A-2006N. The master/drone relationship allows multiple slide show presenters 1910 to use the same slide show master object 2002 at the same time without affecting each other's active slide shows. The drone object 2004 is a clone of the master 2002. Each drone object 2004 has a limited life span, and is not permanent (for example, the drone 2004 is not stored in a content repository). When the slide show presenter 1910 ends the slide show 1906, the drone 2004 is destroyed.

Presentation attendees 118 can view an ongoing slide show 1906 using a browser 1810 on a computer 1806. The slide show presenter distributes a link for a running slide show 1906 to presentation attendees 118 who would like to view this slide show on their own devices 1806. An attendee receives this slide show link, and opens it on a browser 1810. This link takes the user to a web-based slide show viewer. This web-based viewer has the full-screen modality of the slide show, but not the functionality to change slides, view notes, and the like. In some embodiments, an attendee device 1806 can be used to project the slide show for a wider audience.

Embodiments of the disclosure can be implemented in digital electronic circuitry, or in computer hardware, firmware, software, or in combinations of them. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosure have been described. Nevertheless, it will be understood that various modifications may be made without departing from the spirit and scope of the disclosure. Accordingly, other implementations are within the scope of the following claims.

What is claimed is:

1. Computer-readable media embodying instructions executable by a first computer to perform functions comprising:
receiving a first user input from a user of the first computer, wherein the first user input represents a command to take control of an application executing on a second computer;
responsive to receiving the first user input, taking the control of the application executing on the second computer;
receiving a second user input from the user of the first computer while keeping the control of the application executing on the second computer, wherein the second user input represents a command to pass the control of the application to a third computer; and
responsive to receiving the second user input, passing the control of the application to the third computer.

2. The computer-readable media of claim 1, wherein the functions further comprise:
receiving a third user input from the user of the first computer prior to passing the control of the application to the third computer, wherein the third user input represents a command to invite a user of the third computer to take the control of the application; and
responsive to receiving the third user input, sending a first message to the third computer, wherein the first message represents an invitation to take the control of the application;
wherein the control of the application is passed to the third computer only subsequent to an acceptance of the invitation to take the control of the application.

3. The computer-readable media of claim 2, wherein the first message further represents:
an identifier of the second computer;
an identifier of the application; and
a starting time and a duration for an interval, wherein the user of the third computer can take the control of the application only during the interval.

4. The computer-readable media of claim 2, wherein the functions further comprise:
receiving a second message from the third computer prior to passing the control of the application to the third computer, wherein the second message represents an acceptance of the invitation to take the control of the application; and
responsive to receiving the second message, and prior to passing the control of the application to the third computer, displaying an indication of the acceptance of the invitation to take the control of the application.

5. The computer-readable media of claim 2, wherein the functions further comprise:
sending the first message to the third computer prior to taking the control of the application executing on the second computer.

6. The computer-readable media of claim 2, wherein the functions further comprise:
sending the first message to the third computer subsequent to taking the control of the application executing on the second computer.

7. The computer-readable media of claim 1, wherein the functions further comprise:
receiving a third user input from a user of the first computer subsequent to passing the control of the application to the third computer, wherein the third user input represents a command to revoke the control of the application executing on the second computer; and
responsive to receiving the third user input, revoking the control of the application executing on the second computer.

8. Computer-readable media embodying instructions executable by a first computer to perform functions comprising:
receiving a first message from a second computer, wherein the second computer has control of a application executing on a third computer, and wherein the first message represents a passing of the control of the application from the second computer to the first computer;
responsive to receiving the first message, displaying an indication of the passing of the control of the application; and
responsive to receiving the first message, taking the control of the application.

9. The computer-readable media of claim 8, wherein the functions further comprise:
receiving a second message from a second computer prior to receiving the first message, wherein the second message represents an invitation to take the control of the application; and
responsive to receiving the second message, displaying an indication of the invitation to take the control of the application.

10. The computer-readable media of claim 9, wherein the second message further represents:
an identifier of the third computer;
an identifier of the application; and
a starting time and a duration for an interval, wherein the user of the first computer can take the control of the application only during the interval.

11. The computer-readable media of claim 9, wherein the functions further comprise:
subsequent to displaying the indication of the invitation to take the control of the application, receiving a first user input from the user of the first computer, wherein the first user input represents a command to accept the invitation to take the control of the application; and
responsive to receiving the first user input, sending a third message to the second computer, wherein the third message represents an acceptance of the invitation to take the control of the application;
wherein the control of the application is passed to the first computer only subsequent to sending the third message to the second computer.

12. The computer-readable media of claim 8, wherein the functions further comprise:
receiving a second user input from the user of the first computer while keeping the control of the application executing on the third computer, wherein the second user' input represents a command to pass the control of the application to the second computer; and
responsive to receiving the second user input, passing the control of the application to the second computer.

13. The computer-readable media of claim 8, wherein the functions further comprise:
receiving a second user input from the user of the first computer while keeping the control of the application executing on the third computer, wherein the second user input represents a command to pass the control of the application to a fourth computer; and
responsive to receiving the second user input, passing the control of the application to the fourth computer.

14. A computer-implemented method for a first computer, the method comprising:
receiving a first user input from a user of the first computer, wherein the first user input represents a command to take control of a application executing on a second computer;
responsive to receiving the first user input, taking the control of the application executing on the second computer;
receiving a second user input from the user of the first computer while keeping the control of the application executing on the second computer, wherein the second user input represents a command to pass the control of the application to a third computer; and
responsive to receiving the second user input, passing the control of the application to the third computer.

15. The computer-implemented method of claim 14, further comprising:
receiving a third user input from the user of the first computer prior to passing the control of the application to the third computer, wherein the third user input represents a command to invite a user of the third computer to take the control of the application; and
responsive to receiving the third user input, sending a first message to the third computer, wherein the first message represents an invitation to take the control of the application;
wherein the control of the application is passed to the third computer only subsequent to an acceptance of the invitation to take the control of the application.

16. The computer-implemented method of claim 15, wherein the first message further represents:
an identifier of the second computer;
an identifier of the application; and
a starting time and a duration for an interval, wherein the user of the third computer can take the control of the application only during the interval.

17. The computer-implemented method of claim 15, further comprising:
receiving a second message from the third computer prior to passing the control of the application to the third computer, wherein the second message represents an acceptance of the invitation to take the control of the application; and
responsive to receiving the second message, and prior to passing the control of the application to the third computer, displaying an indication of the acceptance of the invitation to take the control of the application.

18. The computer-implemented method of claim 15, further comprising:
sending the first message to the third computer prior to taking the control of the application executing on the second computer.

19. The computer-implemented method of claim 15, further comprising:
sending the first message to the third computer subsequent to taking the control of the application executing on the second computer.

20. The computer-implemented method of claim 14, further comprising:
receiving a third user input from a user of the first computer subsequent to passing the control of the application to the third computer, wherein the third user input represents a command to revoke the control of the application executing on the second computer; and
responsive to receiving the third user input, revoking the control of the application executing on the second computer.
